(19) United States
(12) Patent Application Publication
(10) Pub. No.: US 2016/0120322 A1
(43) Pub. Date: May 5, 2016

(54) Bracelet Towel Clip

(71) Applicant: O2COOL, LLC, Chicago, IL (US)

(72) Inventor: Harvey Katz, Boca Raton, FL (US)

(21) Appl. No.: 14/933,515

(22) Filed: Nov. 5, 2015

Related U.S. Application Data
(60) Provisional application No. 62/075,437, filed on Nov. 5, 2014.

(51) Int. Cl. A47C 7/62; A44C 5/00; A44C 15/00; F16B 2/10; A47C 1/14

(52) U.S. Cl. CPC A47C 7/62; F16B 2/10; A47C 1/14; A44C 15/0085; A44C 5/0007

(57) ABSTRACT

A towel clip comprising first and second members and a spring, the first member having a first mating portion and the second member having a second mating portion. The first and second members are pivotally connected to each other and the spring biases the first mating portion toward the second mating portion. The towel clip is movable from a closed position toward a chair-frame passage position. A towel may be secured to a chair by placing the towel clip around a portion of a frame member when the towel clip is in the chair-frame passage position and by allowing the spring bias to move the towel clip toward the closed position. The towel clip may be placed around a wrist or ankle of a user such that the first and second members of the towel clip collectively surround the wrist or ankle of the user.

### CROSS-REFERENCE TO RELATED APPLICATIONS

This application is a nonprovisional application claiming priority to provisional application 62/074,437 filed on Nov. 5, 2014.

### STATEMENT REGARDING FEDERALLY SPONSORED RESEARCH OR DEVELOPMENT

Not applicable.

### APPENDIX

Not applicable.

### BACKGROUND

The present description relates to a towel clip, and, more particularly, to a towel clip that may be worn as a decorative bracelet when not in use as a towel clip.

A towel clip is intended to secure a towel in place. Sunbathers may use a towel clip to secure a towel to the frame of a beach chair. Towel clips may also be used to fasten towels to towel racks and even to the edge of tables.

One of the problems with towel clips is that they may be misplaced when not in use. For example, when removing a towel from a beach chair, the towel clips are removed and typically placed aside. There is no convenient storage location for the towel clips when not in use.

### SUMMARY

One aspect of the present invention is a method comprising moving a towel clip from a closed position toward a chair-frame passage position. The towel clip comprises a first member, a second member, and a spring. The first member has a first mating portion and the second member has a second mating portion. The first and second members are pivotally connected to each other. The spring biases the first mating portion toward the second mating portion. The closed position is a position in which the first and second mating portions are in contact with each other and biased against each other. The chair-frame passage position is a position in which the first and second mating portions are spaced sufficiently apart from each other such that a portion of a frame member of a chair is capable of being passed between the first and second mating portions. The method comprises securing a towel to a chair by placing the towel clip around a portion of a frame member of the chair when the towel clip is in the chair-frame passage position and allowing the spring bias to move the towel clip toward the closed position. The towel is oriented such that a portion of the towel is squeezed between the first and second mating portions of the towel clip while the first and second members of the towel clip collectively surround the portion of the frame member of the chair. The method comprises placing the towel clip around a wrist or ankle of a user such that the first and second members of the towel clip collectively surround the wrist or ankle of the user.

Another aspect of the invention is a towel clip comprising a first member, a second member, and a spring comprising first and second legs. The first member comprises a first mating portion and the second member comprises a second mating portion. The first member is connected to the first leg and the second member is connected to the second leg. The first and second members are pivotally connected to each other via the spring. The spring biases the first mating portion toward the second mating portion.

### BRIEF DESCRIPTION OF THE DRAWINGS

FIG. 1 is a side view of an embodiment of a towel clip of the present invention;

FIG. 2 is a front view of the towel clip shown in FIG. 1;

FIG. 3 is rear view of the towel clip shown in FIGS. 1-2;

FIG. 4 is perspective view showing two towel clips similar to the towel clips shown in FIGS. 1-3 securing a towel on a beach chair;

FIG. 5 is an exploded view of the towel clip shown in FIGS. 1-3;

FIG. 6 is a side view of the towel clip shown in FIGS. 1-3 and 5 opened and in a chair-frame passage position; and

FIG. 7 is a perspective view showing the towel clip shown in FIGS. 1-3, 5, and 6 opened and in a wrist-or-ankle passage position.

### DETAILED DESCRIPTION

The towel clip and method of use described below and illustrated in the appended drawings solves the aforementioned problem of misplacing towel clips by providing for convenient storage of a towel clip when the towel clip is not in use.

The towel clip described below and illustrated in the appended drawings has particular utility in conjunction with beach chairs, patio chairs and the like, and therefore will be explained in that context with the understanding that this is a non-limiting explanation and non-limiting context.

The following is a general description. References to directions (e.g., top, bottom, left, right) is for ease of understanding only; references to sizes, shapes and materials are also for ease of understanding only. Nothing in this application should be construed as limiting.

Referring to the Figures, a towel clip 10 of the present embodiment is generally circular when viewed from the side, and includes upper and lower portions/members 12, 14 that are substantially semicircular in shape. Clip member 12 has first and second ends 16, 18, and Clip member 14 has first and second ends 20, 22. Each clip member can be a multi-part member as will be described below.

Clip members 12 and 14 are pivotally connected, specifically at their respective first ends 16, 20, by a spring hinge 24. Spring hinge 24 is pre-loaded to bias or urge the respective second ends 18, 22 toward each other.

In one embodiment, each of the two semicircular clip members 12 and 14 is formed of two components, one an interior component 26, 26a, and the other an exterior component 28, 28a. The interior component includes a circular groove 30. In this non-limiting embodiment, the spring hinge is a spiral spring 32 wound around a pin 34, the spiral spring including extensions/legs 36, 36a that fit within the circular groove of the semicircular clip members. Preferably, legs 36, 36a extend away from the pin 34 in different directions. More preferably, legs 36, 36a and the spiral spring 32 are formed of a single-piece element. Pin 34 is positioned in suitable apertures 38 within the semicircular clip members.

The second ends 18, 22 are each provided with mating portions (e.g., mating teeth 40, 42, respectively).

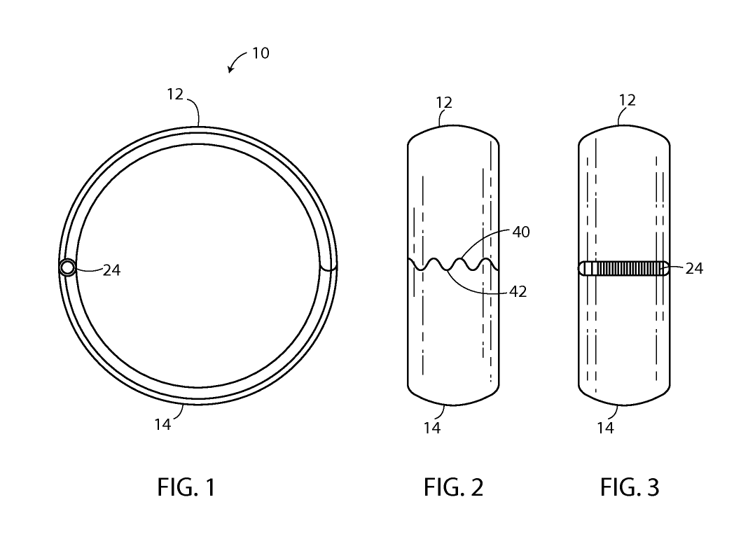

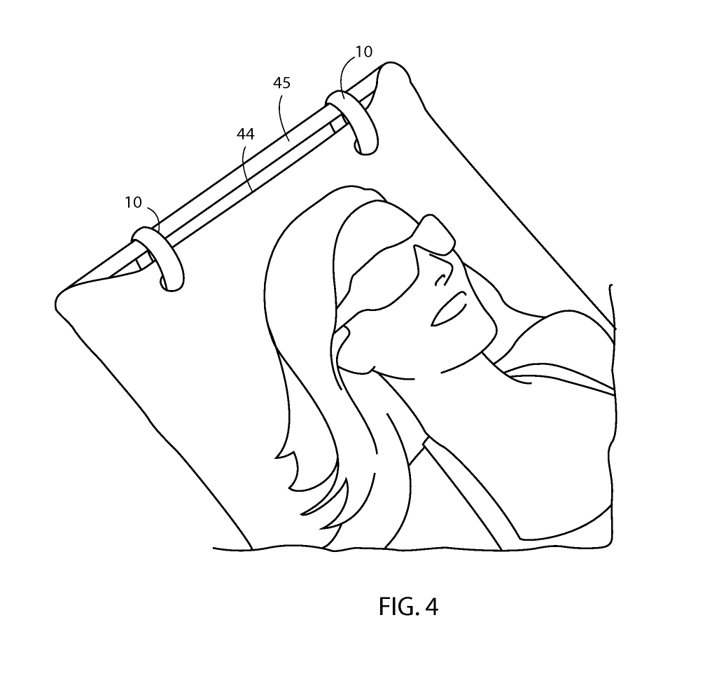

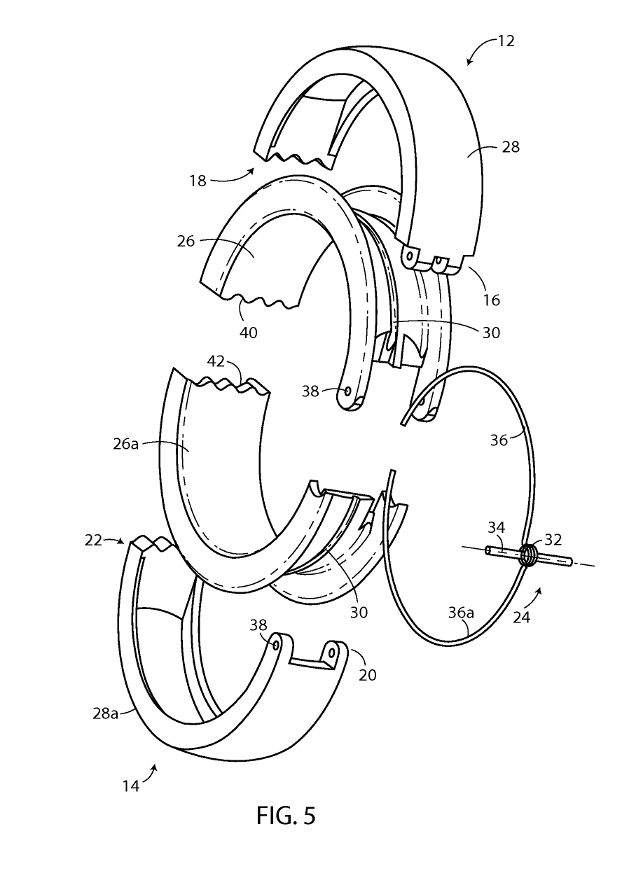

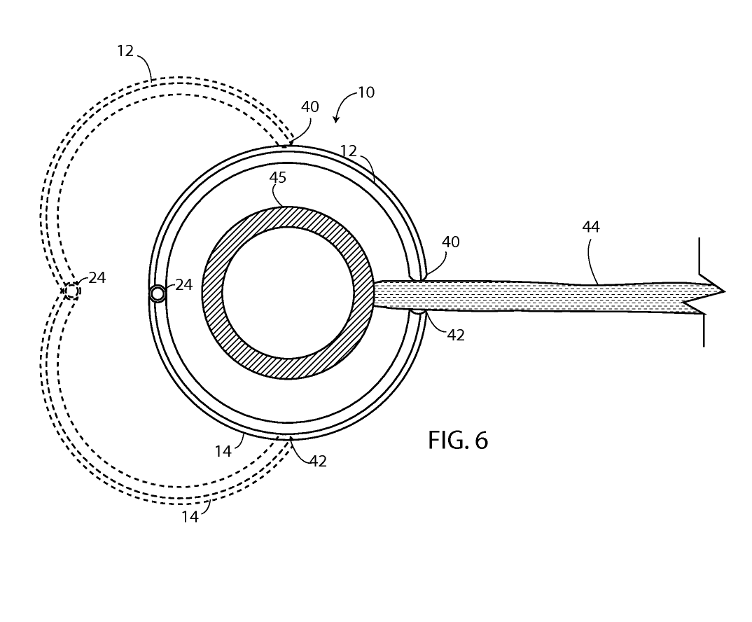

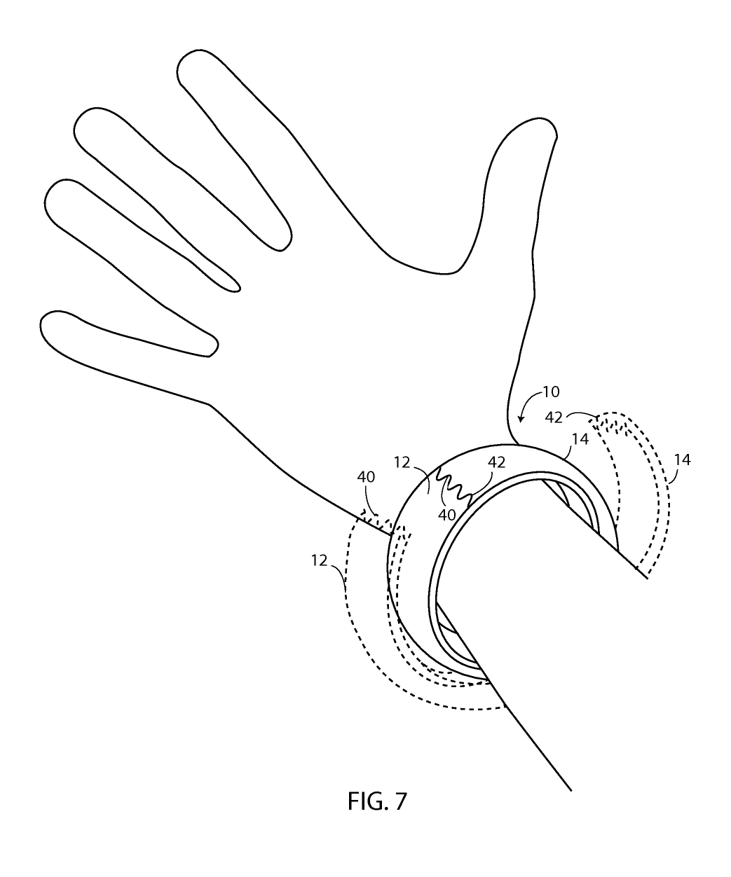

The overall diameter of the clip 10, as seen in FIGS. 1 and 6, is sufficient to allow the clip 10 to secure a towel 44 to a frame member 45 of a beach chair. FIG. 6 is a side view showing the clip 10 surrounding a portion of the frame member 45 (shown in cross-section) and the clip members 12, 14 squeezing a portion of the towel 44. The phantom lines in FIG. 6 show the clip 10 opened and in a chair-frame passage position. The chair-frame passage position is a position in which the mating teeth 40 are spaced sufficiently apart from the mating teeth 42 such that a portion of a frame member of a beach chair is capable of being passed between the mating teeth 40, 42. Although FIG. 6 shows teeth 40 and teeth 42 directly contacting the towel 44, it is to be understood that the towel 44 will be on a portion of the chair and that such portion of the chair (e.g., a fabric webbing of the chair) may be between the teeth 42 and the towel 44. Even with such arrangement, the towel 44 is squeezed by the clip members 12, 14. Preferably, the overall diameter of the clip 10 is sufficient to allow the upper member 12 and the lower member 14 to collectively surround a wrist of a user, as shown in FIG. 7. The phantom lines in FIG. 7 show the clip 10 opened and in a wrist-or-ankle passage position. The wrist-or-ankle passage position is a position in which the mating teeth 40 are spaced sufficiently apart from the mating teeth 42 such that the wrist or ankle of a user is capable of being passed between the mating teeth 40, 42. Preferably, the overall diameter of the clip 10 is sufficient to allow the upper member 12 and the lower member 14 to collectively surround an ankle of a user.

When it is desired to utilize the clip 10 to secure a towel to a beach chair frame, the clip members 12, 14 are “opened” by pivoting clip members 12, 14 about hinge 24 against the bias of the spring thus separating the respective second ends 18, 22 from each other. The clip can be opened to a plurality of different positions. For example, the opened clip 10 can be in the chair-frame passage position as shown in FIG. 6 or the wrist-or ankle passage position as shown in FIG. 7. After a towel 44 is placed on the frame of a beach chair, the opened clip is placed over the frame and towel, and the second ends are released such that the spring biases the second ends 18, 22, toward each other. The mating teeth 40, 42 engage opposite sides of the towel to thus secure the towel in place without damage.

When it is desired to remove the towel from the beach chair, the second ends 18, 22 are manually moved apart and the clip is again “opened,” thus releasing the towel. The clip second ends may then be released and the mating teeth engage each other under the bias from the spring 24 with the clip thus being in the closed position.

The clip is of a size, shape and configuration to conveniently be placed on the wrist or ankle of a user thus functioning as a bracelet. The clip may be decorated as desired, as illustrated in FIG. 4. The spring loaded second ends 18, 22 may be manually opened against the bias of the spring to facilitate placing the bracelet around the wrist or ankle When the clip 10 is opened for the purpose of being worn around the wrist or ankle, the clip can be placed in the wrist-or ankle passage position. In many instances, the diameter of the clip will provide sufficient clearance so that the clip may comfortably by placed over the hand and onto the wrist while remaining in the closed position.

One additional option is that the clip may be stored on the frame of the beach chair rather than be worn as a bracelet. The circular configuration of the clip is such that it will not easily be dislodged during periods of non-use of the beach chair.

In addition, the clip may be conveniently placed through a belt or clipped to a waistband on clothing so that it may conveniently be transported without utilizing space in a beach bag or other container in which towels are stored.

The clip is preferably of plastic (e.g., polystyrene) and the spring is preferably of metal.

It should also be understood that when introducing elements of the present invention in the claims or in the above description of exemplary embodiments of the invention, the terms “comprising,” “including,” and “having” are intended to be open-ended and mean that there may be additional elements other than the listed elements. Moreover, the order in which the steps of any method claim are presented should not be construed in a manner limiting the order in which such steps must be performed.

What is claimed is:

1. A method comprising:
moving a towel clip from a closed position toward a chair-frame passage position, the towel clip comprising a first member, a second member, and a spring, the first member having a first mating portion and the second member having a second mating portion, the first and second members being pivotally connected to each other, the spring biasing the first mating portion toward the second mating portion, the closed position being a position in which the first and second mating portions are in contact with each other and biased against each other, the chair-frame passage position being a position in which the first and second mating portions are spaced sufficiently apart from each other such that a portion of a frame member of a chair is capable of being passed between the first and second mating portions;
securing a towel to a chair by placing the towel clip around a portion of a frame member of the chair when the towel clip is in the chair-frame passage position and allowing the spring bias to move the towel clip toward the closed position, the towel being oriented such that a portion of the towel is squeezed between the first and second mating portions of the towel clip while the first and second members of the towel clip collectively surround the portion of the frame member of the chair;
placing the towel clip around a wrist or ankle of a user such that the first and second members of the towel clip collectively surround the wrist or ankle of the user.

2. A method as set forth in claim 1 wherein the step of placing the towel clip around a wrist or ankle of a user such that the first and second members of the towel clip collectively surround the wrist or ankle of the user comprises:
moving the towel clip toward a wrist-or-ankle passage position, the wrist-or-ankle passage position being a position in which the first and second mating portions are spaced sufficiently apart from each other such that a wrist or ankle of a user is capable of being passed between the first and second mating portions; and
placing the towel clip around the wrist or ankle of the user when the towel clip is in the wrist-or ankle passage position and allowing the spring bias to move the towel clip to the closed position such that the first and second members of the towel clip collectively surround the wrist or ankle of the user.

3. A method as set forth in claim 1 wherein the step of placing the towel clip around a wrist or ankle of a user such that the first and second members of the towel clip collectively surround the wrist or ankle of the user comprises:
placing the towel clip around the wrist of the user such that the first and second members of the towel clip collectively surround the wrist of the user.

4. A method as set forth in claim 3 wherein the towel clip is in the closed position throughout the step of placing the towel clip around the wrist of the user such that the first and second members of the towel clip collectively surround the wrist of the user.

5. A method as set forth in claim 1 wherein the step of placing the towel clip around a wrist or ankle of a user such that the first and second members of the towel clip collectively surround the wrist or ankle of the user comprises:
placing the towel clip around the ankle of the user such that the first and second members of the towel clip collectively surround the ankle of the user.

6. A method as set forth in claim 1 wherein the portion of the frame member of the chair constitutes a first portion of the frame member of the chair, and the method further comprises placing the towel clip around a second portion of the frame member of the chair when the towel clip is in the chair-frame passage position and allowing the spring bias to move the towel clip to the closed position such that the first and second mating portions are in contact with each other while the first and second members of the towel clip collectively surround the second portion of the frame member of the chair.

7. A method as set forth in claim 6 wherein the first portion of the frame member of the chair is different from the second portion of the frame member of the chair.

8. A towel clip comprising:
a first member comprising a first mating portion;
a second member comprising a second mating portion; and
a spring comprising first and second legs, the first member being connected to the first leg and the second member being connected to the second leg, the first and second members being pivotally connected to each other via the spring, the spring biasing the first mating portion toward the second mating portion.

9. A towel clip as set forth in claim 8 wherein the first mating portion has a first set of teeth and the second mating portion has a second set of teeth, the first and second set of teeth being adapted to interlock with each other when the mating portion of the first member contacts the mating portion of the second member.

10. A towel clip as set forth in claim 8 wherein the spring comprises a spiral spring and a pin, the spiral spring being wound around the pin, the spiral spring being connected to the first and second legs of the spring, the first leg extending away from the pin in a first direction and the second leg extending away from the pin in a second direction, the first direction differing from the second direction.

11. A towel clip as set forth in claim 10 wherein the spiral spring, the first leg, and the second leg are a single-piece element.

12. A towel clip as set forth in claim 8 wherein the first and second members are substantially semicircular in shape and the towel clip forms a substantially circular shape when the towel clip is in a closed position, the closed position being a position in which the first and second mating portions are in contact with each other and biased against each other, the substantially circular shape being of a size that is sufficient to enable the first and second members of the towel clip to collectively surround a portion of a frame member of a chair.

13. A towel clip as set forth in claim 12 wherein the substantially circular shape is of a size that is sufficient to enable the first and second members of the towel clip to collectively surround a wrist or ankle of a user.

14. A towel clip as set forth in claim 8 wherein the first member comprises first and second components, the first and second components of the first member being connected to each other in a manner such that a portion of the first leg of the spring is enclosed by the first and second components of the first member.

15. A towel clip as set forth in claim 14 wherein the second member comprises third and fourth components, the third and fourth components of the second member being connected to each other in a manner such that a portion of the second leg of the spring hinge is enclosed by the third and fourth components of the second member.

16. A towel clip as set forth in claim 8 wherein the first and second members are formed of polystyrene.
